(19) United States
(12) Patent Application Publication
(10) Pub. No.: US 2014/0366707 A1
(43) Pub. Date: Dec. 18, 2014

(54) Touch force adjustment means for piano keys

(71) Applicant: Alan Liu, Millbrae, CA (US)

(72) Inventor: Alan Liu, Millbrae, CA (US)

(21) Appl. No.: 13/916,491

(22) Filed: Jun. 12, 2013

(51) Int. Cl. G10C 3/12

(52) U.S. Cl. CPC G10C 3/12
USPC 84/435

(57) ABSTRACT

Means for adjusting the touch force required to depress the keys of a piano within the range normally preferred by pianists, comprising of an adjustable weight member located in a slot bored through the side of the piano key. The slot is in a shape that allows the weight to move in a direction parallel to the length of the piano key. Precise adjustment of the touch force necessary to depress a piano key is achieved by moving the weight member within the slot, thereby increasing or decreasing its distance from the key fulcrum.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of Invention

The subject matter of this disclosure is in the field of piano keys.

2. Background of the Invention

In the usual piano action, a felt-covered piano hammer is caused to pivot about a center and strike a respective piano string in response to the force of a player's finger applied to a lever, namely a piano key, acting on a fulcrum. The lever, or piano key, actuates the hammer operating mechanism, of which there are many types. The weight of the piano hammers varies over the scale (a standard piano consisting of 88 keys and hammers) normally from about ten to twelve grams at the bass end of the scale, to about three to four grams at the treble end of the scale. The mechanical advantage of the action is less than unity (usually in the range of about fifteen-hundredths to about two-tenths) such that a downward displacement of the lever or key of about nine millimeters will move the hammer upward through a vertical distance of approximately forty-five millimeters. As a result, the force required to depress the key will be several times the weight of the hammer itself, plus the weight of the other parts and the internal friction of the piano action. The sum of these weights, minus the lever's weight on the playing side of the piano key, is the minimum touch force required to displace the lever. For most pianos, this force will typically range from between about seventy grams to about one-hundred grams at the bass end of the keyboard and from between about forty grams to about forty-five grams at the treble end. Generally, a touch force above seventy grams or below forty grams is not preferable. Most professional pianists prefer a touch force that is usually between 50 grams to 60 grams. Notwithstanding, some pianists may prefer a touch force that is not within this range.

The minimum touch force necessary to depress a piano key is dependent on the weight of the piano key and the distance between the key's center of gravity and the fulcrum. To wit, the minimum touch force for key depression can be manipulated via adjusting the weight of the key or the position of the key's gravity center.

Until now, manipulation of the minimum touch force for piano key operation has been accomplished by the usual and conventional prior art practice of placing lead weights into holes bored through the sides of the piano keys. Typically these weights are about fourteen grams, wherein the proper distance of the weights from the fulcrum of each key is determined so that all the keys have operating touch forces in the preferred range. While suitable for permanently setting the operating touch force of a piano key, the boring of holes for lead weights into the sides of piano keys is tedious and subject to multiple sources of error. For instance, the position of the lead weights is fixed and cannot be adjusted. Unadjustable weight positions are unsatisfactory because the hammers associated with a piano key can lose weight over time (e.g., from being worn) so that the originally calculated weight position would no longer be within the preferred range of operating touch forces.

### SUMMARY OF THE DISCLOSED EMBODIMENT

In view of the foregoing, an object of this disclosure is to describe a piano key with an operating touch force adjustment means. Suitably, the adjustment means may be manipulated to obtain a uniform operating touch force across the keyboard of a piano. In one embodiment, the piano keys with the disclosed touch force adjustment means may be used to customize the operating touch force of a keyboard to the tastes of a particular pianist. In one embodiment, the disclosed piano key defines an elongated lever on a fulcrum wherein the lever features an oblong cut-out with a movable weight for adjusting the key's center of gravity relative to the fulcrum.

### BRIEF DESCRIPTION OF THE FIGURES

Other objectives of the invention will become apparent to those skilled in the art once the invention has been shown and described. The manner in which these objectives and other desirable characteristics can be obtained is explained in the following description and attached figures in which:

FIG. 1 is an exploded perspective view of a piano key on a fulcrum;

FIGS. 2A and 2B are perspective views of the piano key of FIG. 1 with a weight shown in alternative positions;

FIGS. 3A, 3B, and 3C are respectively side, front, and top views of the adjustable weight; and,

FIGS. 4A and 4B are top and side views of a security strip.

In the figures the referenced numerals are as follows:
100) piano key;
1) Nail;
2) Rear Bed Plate;
3) Screws;
4) Center Bed Plate;
5) Balancing Nail;
6) Key Lever;
7) Key Surface;
8) Key fulcrum;
9) Security Strip:
10) Weight; and,
11) Oblong cutout.

It is to be noted, however, that the appended figures illustrate only a typical embodiment of the disclosed apparatus and are therefore not to be considered limiting of its scope, for the disclosed apparatus may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

Generally disclosed is a piano key with a means for adjusting the touch force required to depress the same when incorporated into a keyboard. In one embodiment, the piano key defines an elongated lever on a fulcrum wherein the lever features an oblong cut-out with a movable weight for adjusting the key's center of gravity relative to the fulcrum. The more specific details of the disclosed piano key are disclosed with reference to the attached figures.

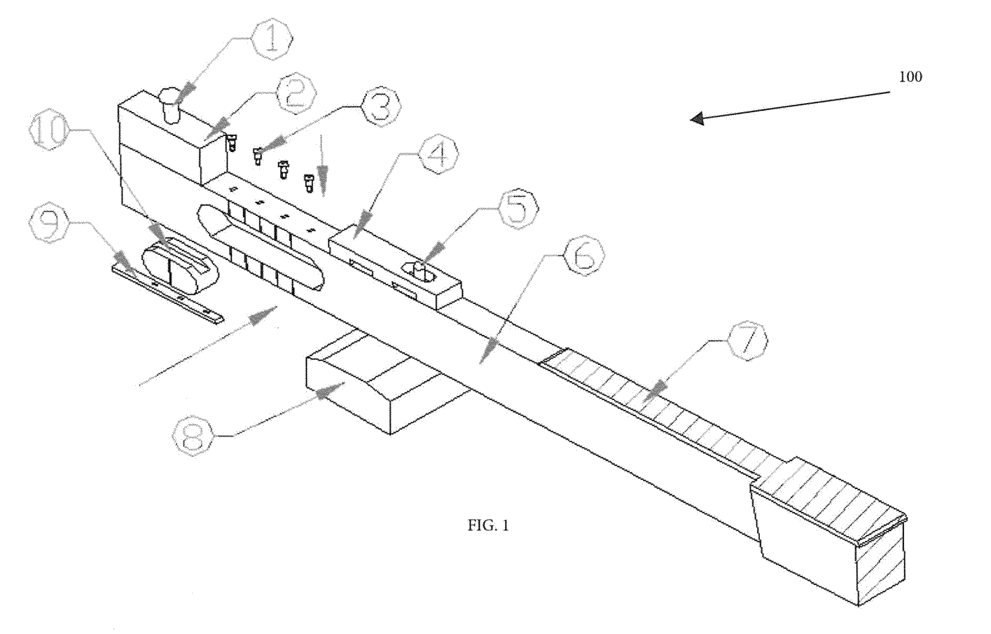

FIG. 1 is an exploded perspective view of a piano key 100. As shown, the piano key 100 is defined by an elongated key lever 6 that is positioned on a fulcrum 8. At one end of the key lever 6 is the key playing surface 7 (the point where touch force is applied to the piano key by a pianist). At another end of the key lever are a nail 1 and a rear bed plate 2 for coupling the piano key 100 to a hammer (not shown). Suitably, the key lever 6 and the fulcrum 9 are pivotably coupled by a balancing nail and a center bed plate. In one mode of construction, the key surface, center bed plate, and rear bed plate are adhered to the key lever by glue or other adhesive.

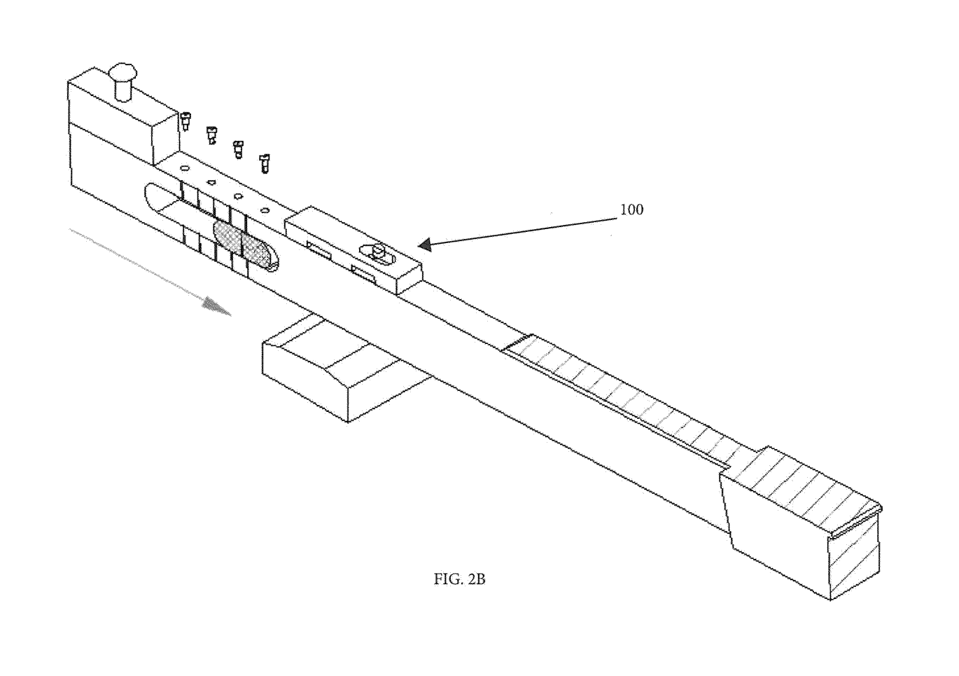

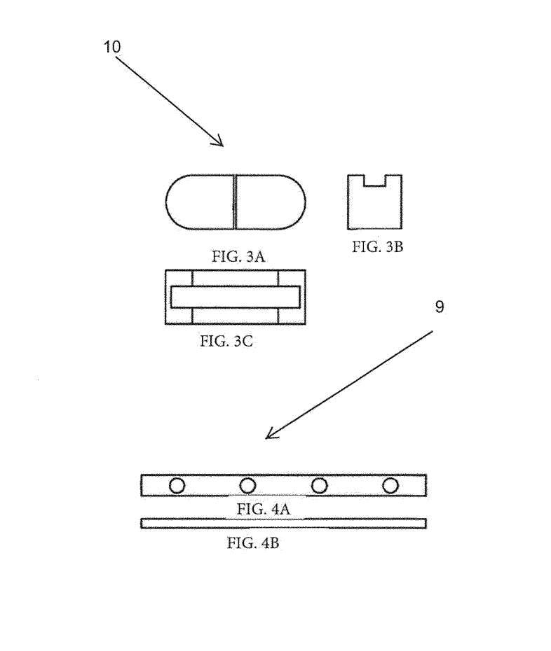

Still referring to FIG. 1, an oblong cutout 11 may preferably be provided to the key lever 6 at a location along its 6 length in between the rear and center bed plates 2, 4. Preferred dimensions for the cutout 11 are sixty-millimeters length plus ten and one-tenth to ten and three tenths millimeters width and depth. In one embodiment, a weight 10 may be slidably provided to the oblong cutout 11, wherein a security strip 9 may operate as a rail or track for guiding movements of the weight 10 within the cutout 11. (See FIGS. 3A through 4B). As shown, the track or security strip 9 may be installed via screws interacting with corresponding screw holes in the security strip 9. In a preferred mode of operation, the freedom of slidable movement of the weight can be manipulated via raising or lowering the screws to press the security strip 9 against the weight 10.

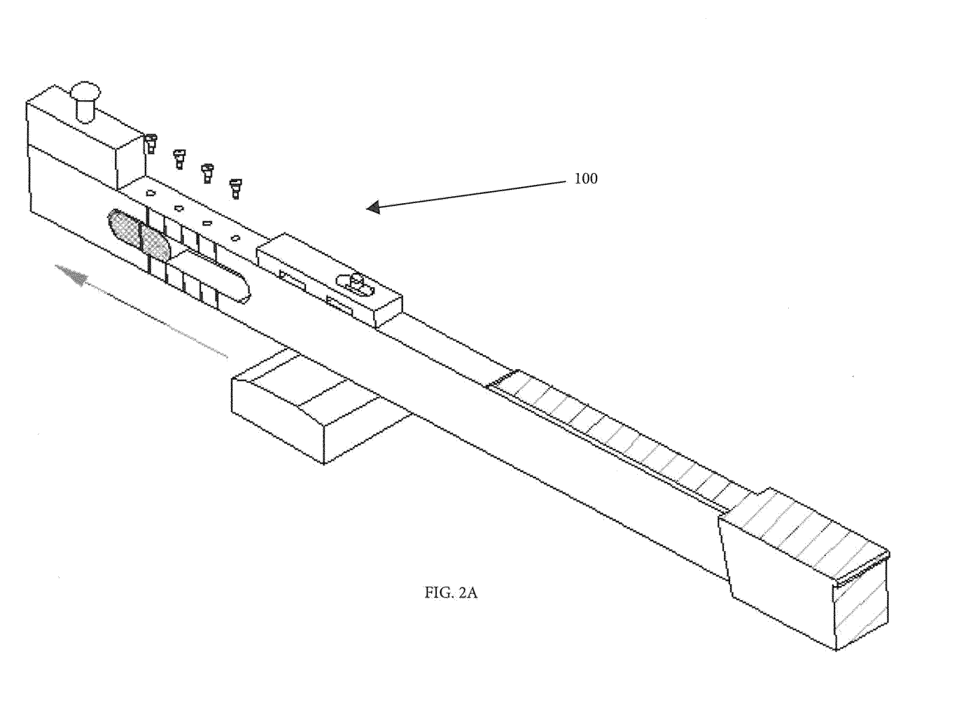

FIGS. 2A and 2B are perspective views of a constructed configuration of the piano key 1 of FIG. 1. Taken together, the two figures illustrate the operation of the disclosed piano key. Referring first to FIG. 2A, the piano key 100 features the weight 10 at a first position within the cutout 11 so that the key 100 has a first operating touch force. Referring next to FIG. 2B, the piano key 100 features the weight 10 at a second position within the cutout 11 so that the key as a second operating touch force. In operation, the weight may be slidably provided to any point along cutout 11 for manipulating the key's 100 operating touch force. That is to say: when the weight is moved towards the direction of rear bed plate, the key lever's operating touch-force will increase; when the weight is moved towards the center bed plate, the key lever's operating touch-force will reduce. In one embodiment a scale may be provided along the edges of the cutout for gauging the position of the weight or the operating touch force of the key. Suitably, the scale may have five to eight millimeter spacing.

FIGS. 3A, 3B, and 3C are respectively side, front, and top views of the adjustable weight. FIGS. 4A and 4B are top and side views of a security strip. Together the figures illustrate the coupling of the security strip 9 and the weight 10 while in the cutout 11. Referring to said figures, the weight 10 features a track in its top side so that the security strip may sit within the track and function as a rail or guide for slidable movements.

Referring only to FIGS. 3A through 3C, in a preferred embodiment: the weight 10 is twenty-six millimeters long, nine and nine-tenths to ten millimeters thick, and ten millimeters wide; the track of the weight 10 is two millimeters deep and four millimeters wide. A calibration line may suitably be provided to the weight on its side so that the same can associated the position of the weight with the scale of the cutout 11.

Referring to FIGS. 4A and 4B, four holes are provided to the security strip 9. Suitably, the spacing between the end holes and the edges is six millimeters while the spacing between the holes twelve millimeters. Preferably, the width of the security stripe is three and four-tenths to three and six-tenths millimeters. In one embodiment, the strip 9 is constructed of one and two-tenths to one and a half millimeter copper or sheet iron.

Disclosed is a system for adjusting the piano key's operating touch force. This system allows on-the-spot customized adjustment of a piano key's operating touch force. When installed on a keyboard, all keys can have a pianist's preferred operation touch force.

I claim:

1. A piano comprising:
a key lever on a fulcrum; and,
wherein the key lever features a movable weight for adjusting the key's center of gravity relative to the fulcrum,
whereby a player's preference for key pressure resistance may be accomplished.

2. The piano of claim 1 wherein said key lever further defines a cutout.

3. The piano of claim 2 wherein said cutout is operably configured to receive a weight.

4. The piano of claim 3 wherein position of said weight may be slidable forward and backward.

5. The piano of claim 4 wherein said adjustable weight is secured with screws.

6. The piano of claim 1 wherein said key lever features a touch force in a range of between 50 to 60 grams.

7. The piano of claim 3, wherein said weight is about 14 grams.

8. The piano of claim 2, wherein said cutout is approximately 60 mm in length.

9. The piano of claim 2, wherein said cutout further features a scale along the edges of the cutout for gauging the position of a weight within said cutout.

10. The piano of claim 9, wherein said scale defines a range of about 5 to 8 mm spacing.

11. I claim a key lever for a piano that defines an elongated lever on a fulcrum wherein the lever features a cutout with a movable weight disposed in said cutout for adjusting the key's center of gravity relative to the fulcrum.

12. The key lever of claim 11 wherein said weight is moved towards the direction of a rear bed plate the key lever's touch force will increase, whereas when the weight is moved towards the center of a bed plate the key levers operating touch force will reduce.

13. The key lever of claim 11, wherein said cutout features a scale.

14. The key lever of claim 13, wherein said scale defines a range of about 5 to 8 mm spacing.

15. A method of adjusting the key lever pressure of a piano key comprising the steps of:
a. obtaining a key lever;
b. ensuring that a cutout is defined in said key lever;
c. moving a weight disposed in said cutout either forward or backward,
d. whereby the operating touch force necessary for playing the piano is variable according to user preference.

16. The method of claim 15 wherein said touch force is in the range of 50 to 60 grams.

17. The method of claim 15 wherein said weight disposed in said cutout is about 14 grams.

18. The method of claim 15 wherein said cutout is oblong.

19. The method of claim 15 wherein said cutout further defines a scale.

20. The method of claim 19 wherein said scale features a range of about five to about 8 mm spacing.
